(19) United States
(12) Patent Application Publication
(10) Pub. No.: US 2020/0294043 A1
(43) Pub. Date: Sep. 17, 2020

(54) METHOD AND SYSTEM FOR IDENTIFYING USERS IN TWO DOMAINS

(71) Applicant: Loyalty Angels Ltd, Bagshot, Surrey (GB)

(72) Inventors: Lee David Clarke, Bagshot, Surrey (GB); David Ian Gower, Bagshot, Surrey (GB)

(21) Appl. No.: 16/765,771

(22) PCT Filed: Nov. 27, 2018
(86) PCT No.: PCT/GB2018/053428

§ 371 Date: May 20, 2020

(30) Foreign Application Priority Data
Nov. 27, 2017 (GB) 1719666.8

(51) Int. Cl. G06Q 20/38; G06Q 20/40; G06Q 30/02; G06Q 20/20; H04L 29/06; H04L 9/32

(52) U.S. Cl. CPC G06Q 20/3829; G06Q 20/4014; G06Q 20/385; G06Q 20/3827; H04L 9/3242; G06Q 30/0238; G06Q 20/20; G06Q 20/387; H04L 63/102; G06Q 30/0229

(57) ABSTRACT

A computer-implemented method for identifying a user in each of two separate domains using a single user identifier via a single identification system so as to permit authorisation of at least one action, the method comprising: receiving a request to identify the user and authorise an action in the first domain; performing a first identification process to identify the user in the first domain, the first identification process comprising: receiving input data relating to a user at an identification system; obtaining a first user identification key from the input data for identifying the user in a first domain and for authorising an action based upon the identification in the first domain; identifying the user in a first domain by using the first identification key; authorising an action based at least in part on the identifying step: and terminating the first identification process; and performing a second identification process to identify the user in the second domain after the first user identification key is obtained and before the termination of the first identification process, the process being distinct from the steps of identifying the user in the first domain and authorising the action, and comprising: obtaining a second user identification key based upon at least the first identification key and a system identifier; and identifying the user in the second domain by using the second identification key.

### TECHNICAL FIELD

The present disclosure relates to methods and systems for identification of users in two domains, particularly in relation to loyalty and payment systems.

### BACKGROUND

Many different types of user-interaction and processing systems exist. They are used in a host of diverse industries for many different purposes. Many of these are directed towards facilitating user interaction with a distributed system, often in dispersed geographic locations, to enable a local function to occur. For example, different transport systems may have different user tokens (tickets) to enable a user to travel geographically between two different locations, with an interaction at one location enabling access to the transport system to be provided at that location. Similarly, automated biometric identity systems exist to verify the identity of a person carrying a biometric passport before granting entry into a different country. Also, transactions in goods and services using a bank-issued user token (payment card for example) or mobile device can also be carried out in geographically distant locations with central authentication of the user token presented by the user to support the desired transaction. Loyalty programme systems used by merchants, make use of personalised loyalty user tokens specific to each user to allow the system to monitor and track each user's data relating to user interaction with their geographically distributed system, whilst encouraging the user to interact with the system by offering rewards. So a loyalty token acts to identify a user so that interaction data collected by the system can be analysed by the dedicated loyalty system which is under the control of the merchant. Many other examples exist, such as access systems for buildings, automatic toll systems on motorways, or portable security keys.

Each of these systems may be considered to serve the purpose of identifying the user to the system in order for an action to be accessed or permitted. To permit the action, the user's identity must first be obtained, compared to pre-stored specific data or criteria and a response returned, that grants permission to proceed with the action, denies permission or requests an intermediary step to be performed. The authorisation and/or identification may be performed locally or remotely. Each of the above-mentioned systems may be considered to be a combination system that acts as an identification system first before performing an authorisation, authentication or permissions process. Further systems may be incorporated, such as data extraction systems, as evidenced in International Patent Application no. PCT/GB2016/053685, or notifications systems, although these will not be considered in the present application.

Given the number of different systems that are present in even just one type of industry, it is sometimes the case that more than one identification-authentication system is used in a specific situation or at a specific location. At airports, for example, a person attempting to board a plane may be required to present both their biometric passport and a boarding pass. In retailers, a user may often be asked to present a loyalty token, for use by a dedicated loyalty programme system under the control of the merchant, and a payment token, for use by a general purpose payment system not under the control of the merchant, to perform a dual identification before the payment is authorised. In fact, the payment token is general purpose and so is designed to be used at multiple different Point-Of-Sale (POS) terminals of different merchants.

Unfortunately, these identification-authentication systems tend to be incompatible as they are controlled by different parties and serve different purposes; one specific, the other general purpose. Furthermore, they tend to act as closed systems so as to maintain their integrity and security, having limited external functionality so that data can only be input and output at specific locations. Because of this, the use of separate individual systems for identification and authentication which have their own, different requirements imposes delays on the overall identification-authentication process. A further disadvantage arises in requiring more than one token or electronically verifiable identifier to be carried by a user to interact with the different systems. A greater disadvantage is presented in maintaining and operating two incompatible systems simultaneously, requiring separate software, hardware, tokens and knowhow for each system.

Thus, in many industries there is a desire to aggregate several identification-authentication systems to prevent delays in the overall process, to reduce the required hardware, software and knowhow, and particularly to prevent users from having to carry a multitude of different types of user token to facilitate interaction with the different systems.

Some attempts have been made to combine these different identification-authentication systems, by bolting one system onto another so that the processes run consecutively. In these circumstances, the back end of one system is integrated with another system's front end and this can reduce processing issues and speed up the reconciliation of interactions with the system. However, whilst such systems simplify the processing task for the service provider, they do not solve the problem from the user's perspective; there is still a delay caused by the user's interaction with the system and the requirements imposed by each system individually.

This delay is caused because many of these systems, operated by market competitors or developed in different environments under different priorities, are incompatible, as discussed above. The requirements in terms of token, operation, authentication and identification differ vastly between each system. One of the biggest problems faced in attempting to aggregate such systems is that certain processes are effectively ‘locked’; the steps required to identify or authenticate the user are fixed. In some cases, this fixed set of events is required for the system to operate correctly, while in other systems the steps are laid out by standards and are at the core of the industry.

One specific example of two co-operating incompatible systems is loyalty programme systems and payment systems. Both these systems can operate at point-of-sale (POS) terminals in retailers or merchants and currently simply co-exist. The loyalty programme systems allow a customer who is purchasing goods or services to be rewarded for their purchase, and in exchange, the merchant is able to gather information relating to that customer to tailor their future offering to the customer. The payment systems provide an intermediate payment facilitation service between the customer and the merchant, (typically involving a remotely-located general-purpose third party authorisation system) permitting the required transaction to be carried out securely and without risk to either party.

Currently, a customer is required to first present a loyalty token to accrue points (which are specific to a particular merchant) and access rewards, and secondly to present a general-purpose payment card or other token (such as their digital wallet) to allow payment to be made. The presentation of the loyalty token occurs before payment has begun and is facilitated as a separate process. One issue arises from the fact that the customer is required to physically present; it is common for the customer to forget to present their loyalty token.

Moreover, because merchants operating particular schemes require the members to identify themselves at checkout, the customer has to carry a token for every scheme for which they are a member at all times. Carrying multiple plastic loyalty cards (tokens) in a physical wallet or purse, all the time, represents significant inconvenience to customers, and can result in customers not carrying particular tokens.

Current schemes also have deficiencies in terms of data insights and the value to business. Customer loyalty is big business and merchants spend significant sums on implementing and operating schemes. The purpose of a scheme is to encourage the merchant's customers to be loyal—i.e. to maintain and preferably increase the customer's propensity to shop with that merchant, thus maintaining or increasing market share. While every piece of checkout data is valuable to the merchant, the value of the data is only maximized if the customer identifies themselves as a member of the loyalty scheme at the checkout. As such, every time a customer forgets to present their token, or can't present as they can't find it, or they have a big queue behind them waiting so they decide not to, is a potential lost opportunity for the merchant. No token means the data cannot be personalized. As perception of value increases significantly according to the personal relevancy to the customer of what is being offered, customer forgetfulness or not being able to find their card is damaging to business.

Further inadequacies are seen in efficiency at the POS. Customers are not in the habit of having their token readily available to hand without being prompted. It is usually the scenario that the checkout operator completes scanning all the shopping items, and then, before completing the transaction, asking the customer if they have a loyalty card. If the customer does, then this usually prompts panicked fumbling around for the token in pockets, bags, purses, handbags and wallets, all with a queue of people waiting behind. The embarrassment factor should not be underestimated here, where the member experiences a distinct urge not to present the loyalty card to avoid the situation of potentially holding up other people. This is tipping point where the effort to present the token is seen as to outweigh the relatively modest reward or points. This ‘customer fumble-time’ is a distinctly separate measurement of additional wasted checkout time from other core checkout processes.

There are also many other instances of time wasting processes at the checkout, directly due to the merchant scheme. These are usually as a result of the other forms of token being presented to the checkout staff other than loyalty cards (detailed above)—the most common alternative token being: showing the face of the customer's hand-held device for the digital barcode to be scanned or manually typed in; or the customer verbally confirming their loyalty ID to the checkout staff.

These other forms of ID all take additional precious seconds as they require to be manually inputted by the checkout operator.

The present inventors commissioned market research to quantify the composition of current customer checkout journeys by sector. The research included current ‘Loyalty processing’ time, which is the time taken for a loyalty system to identify the member, and ‘customer find’ time, which is the time required for a customer to find their identifying token to present at the POS terminal.

The purpose of this research was to provide a baseline of average checkout times to identify the potential time savings using embodiments of the present invention. These time savings are applicable to both customers and merchants and are averaged across different sectors.

Overall, averaged transaction times with existing merchant schemes across all tested sectors were as follows:

Loyalty Card processing time: 2.84 seconds

‘Customer Find’ card time: 4.95 seconds

Total opportunity for improvement: 7.79 seconds

The above is based on a total of 15,800 measurements across 6 different sectors.

To briefly explore existing systems, the system of patent application WO 2015/153968 requires a loyalty provider device to be appended onto the remote back-end authorisation part of a payment system, for example to the issuing bank. The loyalty provider device utilises information communicated to the back-end system to look up a loyalty identifier and modifies the authorisation response to be sent back to the point-of-sale. The payment approval process has to be restarted once this has occurred.

While the system of WO 2015/153968 provides a loyalty system in tandem with a payment system, a number of issues identified above still remain. For example, by appending the loyalty device onto the back-end system, significant modifications are required to both the back- and front-end systems to enable them to deal with the complexity of the response to the authorisation request that combines the loyalty and payment information. This may be difficult to retrofit into legacy systems. The potential for latency is therefore highly increased, and if the time to authorise the transaction is increased beyond reasonable limits, the process becomes not commercially viable. The customer is likely to get frustrated if the process is slowed, and the time at the point-of-sale for each customer could increase beyond what would ordinarily be expected if a loyalty card were presented instead.

Furthermore, there is a requirement to re-authorise the transaction by the customer, which is an onerous task, and one that customers may not trust given that the re-authorisation may appear like the customer is paying for their goods or services more than once by entering sensitive details twice.

Other issues can also be identified, such as the fact that the system of WO 2015/153968 cannot be used in payment processes where an authorisation request is not sent as part of the transactional process, such as, for example, contactless or NFC payments, payments below the “floor limit” (a threshold below which authorisation for a transaction is not sought by the merchant) and online transactions where the payment transaction is only processed once the goods are ready for despatch. Further, if the authorisation system is not available for any reason (e.g. due to scheduled or unscheduled maintenance), the system of WO 2015/153968 cannot be used. For customers to rely on these systems, it is necessary for them to work on every occasion the customer shops at the retailer, otherwise customers will not trust them and will revert to using plastic loyalty tokens.

Another patent application that attempts to provide a solution is US 2013/0197991, which describes the use of a ‘special transaction’, mimicking a conventional transaction to enact a loyalty process. This is similar to WO 2015/153968 in that an authorisation request is again required to permit the loyalty payment, and thus shares the same disadvantages. Particularly, there is likely to be a greater distrust among customers having to authorise the process twice for two different transactions, and will result in a large amount of wasted time, because the entire payment process has to be performed twice.

It is against this background that the present invention has been devised.

### SUMMARY OF THE INVENTION

According to an aspect of the invention, there is provided a computer-implemented method for identifying a user in each of two separate domains using a single user identifier via a single identification system so as to permit authorisation of at least one action. The method comprises: receiving a request to identify the user and authorise an action in a first domain; performing a first identification process to identify the user in the first domain, the first identification process comprising: receiving input data relating to the user at the identification system; obtaining a first user identification key from the input data for identifying the user in the first domain and for authorising an action based upon the identification in the first domain; identifying the user in the first domain by using the first identification key; authorising the action based at least in part on the identifying step; and terminating the first identification process; and performing a second identification process to identify the user in a second domain after the first user identification key is obtained and before the termination of the first identification process, the second identification process being distinct from the steps of identifying the user in the first domain and authorising the action, and comprising: obtaining a second user identification key based upon at least the first identification key and a system identifier; and identifying the user in the second domain by using the second identification key.

The first and second domains may be independently controlled. The first and second domains may be configured for differing purposes. Receiving input data relating to a user at an identification system may comprise reading data from a user identifier in the form of a user token. The user token may be a payment card. The identification system may comprise a payment system. The first user identification key may comprise a payment account number.

Obtaining a second user identification key based upon at least the first identification key and a system identifier may comprise comparing at least one of the first identification key and the system identifier with a database of first user identification keys, system identifiers and second user identification keys, and returning a corresponding second user identification key if a corresponding entry in the database exists. The database may be stored in an ancillary system, and data may be redirected to perform the database check. The database may be selected based upon the system identifier. Alternatively, the database may be searched based on encrypted information formed by combining the first identification key and the system identifier. In some configurations, the second identification process or identifying the user in the second domain may comprise receiving a user ID based on the first identification key, and the identification may be performed using that user ID and the system identifier. In this scenario, the user ID and system identifier may be used to simulate the conventional process of receiving information relating to the user, the information presenting the second identification key to the system directly.

Performing the second identification process may comprise modifying the first user identification key. Comparing at least one of the first identification key and the system identifier with the database may comprise comparing the modified first user identification key with the database. Modifying the first user identification key may comprise applying a hashing function to the key to obtain a hashed user identification key. Obtaining a second user identification key may comprise returning a blank data array if no corresponding entry is found in the database. The second user identification process may be performed before the identification of the user in the first domain. Performing the second identification process may comprise modifying the action to be authorised based on the identity of the user in the second domain. Performing the second identification process may comprise temporarily redirecting the obtained first user identification key. The second user identification process may be performed after authorising the action in the first domain. Performing the second identification process may comprise modifying the authorised action based on the identity of the user in the second domain. Identifying the user in the second domain by using the second identification key in a second identification process may comprise simulating receiving, at the identification system, further input relating to the user from a user token or the user.

Receiving input data relating to a user at an identification system may include reading data from a user identifier in the form of a user token. For example, the user token may comprise a payment card, or may be in the form of data communicated by NFC from a user device. The input data may comprise a user's payment account information. The method may comprise encrypting at least some of the received information. Similarly, the user identification key may be in the form of a token, numerical data or a data packet via a communications network, for example. Further user identifiers may be required to perform the authorisation. In a particular embodiment, the user identification key is a payment account number, while the system identifier is a merchant identification number. In another embodiment, the user identification key may comprise an identification number identifying the user in a particular loyalty scheme.

Identifying the user in the second domain may comprise redirecting data obtained during identifying the user in the first domain and used in the first authorisation process to an ancillary system. The ancillary system may be an external module or server, and may be configured to communicate with the identification system. Alternatively, the ancillary system may be part of the identification system, or may be distributed throughout the identification system. The method may include performing a second authorisation process based upon the identification of the user in the second domain. The second authorisation process may comprise modifying the first authorisation process using data retrieved from the second domain pertaining to the user in the second domain.

According to another aspect of the invention, a computer-implemented method for identifying a user in a second domain using a user identifier intended for identification of the user in a first domain within an identification system, the domains being separate. The method comprises: commencing a first identification process to identify the user in the first domain by receiving, from the user identifier, input data relating to the user at the identification system, and obtaining a first user identification key from the input data for identifying the user in the first domain and for authorising an action based upon the identification in the first domain; and having obtained the first user identification key, interrupting the first identification process and performing a second identification process to identify the user in a second domain, the second identification process comprising: obtaining a second user identification key based on the first user identification key and a system identifier; and identifying the user in the second domain by using the second identification key.

According to another aspect of the invention, a computer-implemented method for determining first and second attributes associated with a user using a common system and a common identifier to authorise an action. The method comprises: initiating a first process for determining the first attribute associated with the user; performing an initial part of the first process; performing a second process by temporarily redirecting information from the first process; and performing the remaining part of the first process, wherein: the first process comprises: obtaining information relating to the user at the common system; determining a first identifier from the obtained information for determining a first attribute and for authorising an action based upon the first attribute; determining the first attribute associated with the user by using the first identifier; authorising the action based at least in part on the determination of the first attribute; and terminating the first process; the initial part of the first process comprises at least the steps of obtaining information relating to the user at the common system and determining the first identifier; the second process comprises: determining a second identifier based upon at least the first identifier and a system identifier; and determining the second attribute associated with the user using the second identifier; and the steps of the second process are functionally separate from the steps of the first process.

According to another aspect of the invention, there is provided a system for implementing one of the above methods. The system may include a data input module, a processing module, a first identification module, a second identification module and/or an authorisations module. The data input module may be configured to receive data input to it, such as a user identification key, in the form of a token, numerical data, a data packet via a communications network or otherwise, and to communicate this received data to the processing module. The processing module may be configured to carry out identification processes and/or authorisation processes by communication with the authorisations module and first identification module. The processing module may also be configured to communicate with the first and second identification modules to perform identification of the user in a second domain according to a second identification process. The processing module may use data input received by the data input module and identifying information gathered from that input data to perform a second identification process. The second identification process may comprise initially communicating with the second identification module to confirm that the identifying data may be used to identify the user in the second domain, while the identification is performed against data stored in databases associated with the first identification module and authorisation module. The relevant identification is returned to the processing module by the first identification module, and this identification is confirmed with the second identification module. Effectively, therefore, the second identification module acts as a gateway or facilitator of the second identification process, while the processing module and first identification module operate to perform the identification processes required. An output module may be incorporated to indicate to the user that at least one of the identification process or the authorisation process was successful, and that the action will be, is being or has been performed.

According to another aspect of the invention, a computer-implemented user identification system for identifying a user in each of two separate domains using a single user identifier and obtained via a single identification system so as to permit authorisation of at least one action. The system comprises: Data input means for receiving input data relating to a user at an identification system; First domain ID key means for obtaining a first user identification key from the input data for identifying the user in a first domain and for authorising an action based upon the identification in the first domain; First domain user ID means for identifying the user in a first domain by using the first identification key in a first identification process; Authorising means for authorising the action based at least in part on the identification of the user in the first domain; Second domain ID key means for obtaining a second user identification key based upon at least the first identification key and the system identifier; and Second domain user ID means for identifying the user in the second domain by using the second identification key in a second identification process, wherein: the authorising means is functionally separate from the second domain ID key and the second domain user ID means.

The methods and systems as described above employ a proxy-like identification process by facilitating the temporary interruption of an identification and authorisation process whose elements are fixed in a specific order by protocol or a standardised set of criteria. The system and methods act to re-direct a flow of information received by a processing module to allow the performance of a second identification process during the first identification and authorisation process. The second identification process is advantageously performed using data gathered relating to the first identification process only, allowing a swift and discrete identification of the user. In some cases, the results of this second domain identification process can be used retrieve data from the second domain and use that data to modify the first authorisation process occurring in the first domain to take into account the data from the second domain. This advantageously enables a real-time authorisation process in a first domain to be adjusted to take into consideration information from a second domain during the real-time authentication process in the first domain.

Furthermore, the integration of two contrasting identifications, that would ordinarily require separate identifying data, into a single data flow in order perform multiple actions or communications results in a data efficient, streamlined process that can be implemented in a number of situations to improve the performance of a number of real-world systems. For example, the integration of a payment card identification and authorisation process and a loyalty scheme identification process into a single flow, where the loyalty process effectively interrupts the payment process by being performed either between identification and authorisation or prior to the action of completing the transaction, allows for significant amount of time to be saved at the point of sale. Enablement of the dual identification flow is, in this embodiment, achieved by comparing a merchant ID and a Payment Account Number (PAN) with a pre-existing database, and retrieving a loyalty membership ID that is linked to the PAN and merchant ID. This is then re-input to the system as if it were a loyalty card, to permit the second identification, in the second, loyalty domain, to be performed and appropriate data from the second domain to be retrieved. Time is a particular constraint on the operation of merchants in these situations, where for example loyalty and payment processes access different systems and are required to be performed independently.

Within the scope of this application it is expressly intended that the various aspects, embodiments, examples and alternatives set out in the preceding paragraphs, in the claims and/or in the following description and drawings, and in particular the individual features thereof, may be taken independently or in any combination.

### BRIEF DESCRIPTION OF THE DRAWINGS

One or more embodiments of the invention will now be described, by way of example only, with reference to the accompanying drawings, in which:

FIG. 1 is a schematic block diagram showing a system for performing loyalty and payment processes in relation to the same user token in accordance with an embodiment of the present invention. The system is the same as a conventional system except for the highlighted elements;

FIG. 2 is an interaction diagram illustrating an exemplary conventional payment process including a purchase process and a confirmation process;

FIG. 3 is an interaction diagram illustrating an example of a conventional purchase process;

FIG. 4 is an interaction diagram illustrating an exemplary conventional authorisation process;

FIG. 5 is an interaction diagram illustrating an exemplary conventional confirmation process;

FIG. 6 is an interaction diagram illustrating an exemplary conventional settlement process;

FIG. 7 is a flow chart outlining the operation of a PED driver during the conventional purchase process of FIG. 3;

FIG. 8 is an interaction diagram illustrating an example of a conventional purchase process for contactless payments;

FIG. 9 is an interaction diagram illustrating a loyalty process that may be incorporated into the purchase processes of FIG. 3 or 8 according to embodiments of the invention;

FIG. 10 is an interaction diagram illustrating an alternative loyalty process that may be incorporated into the purchase processes of FIG. 3 or 8 according to embodiments of the invention;

FIG. 11 is a flow chart outlining the operation of a PED driver during the purchase process of FIG. 3 incorporating the loyalty process of FIG. 9 or FIG. 10;

FIG. 12 is a flow chart outlining the operation of a PED driver during the purchase process of FIG. 8 incorporating the loyalty process of FIG. 9 or FIG. 10;

FIG. 13 is a flow chart outlining a process of identifying a user in two domains using a single identifier using a dual-identification system according to an embodiment of the invention;

FIG. 14 is an interaction diagram illustrating a payment process according to an embodiment of the invention; and

FIG. 15 is an interaction diagram illustrating an alternative loyalty process that may be performed during the process of FIG. 13.

### DETAILED DESCRIPTION

In general terms, there is provided a computer-implemented method for identifying a user in each of two separate domains using a single user identifier and obtained via a single identification system so as to permit authorisation of at least one action. The method includes performing both a first identification process and a second identification process, where the second identification process is performed between stages of the first identification process by intercepting information intended for use in the first process.

A dual-identification method for identifying the user in two separate domains using a single system and identifier provides numerous benefits, particularly when applied to a payment processes and loyalty processes, as will be explained below.

A payment cycle is the process by which a customer, hereinafter ‘user’, settles payment for their purchase from a merchant. Payment cycles typically have two main steps: calculation of the cost to the user; and payment for the purchase.

Payment for the purchase is usually performed by using a payment method comprising either: a user token (i.e. a payment card for chip and pin or contactless payment, or a digital wallet using near-field communication (NFC) payments); or cash.

For the purposes of this document, only the payment part of the cycle will be discussed in detail, and particularly payment using a user token. Calculation of the cost to the user prior to initiation of payment using a user token, i.e. adding up the cost of each item the user wishes to purchase to arrive at a total amount or ‘basket total’ for the user to pay, is not considered to be part of this application. However, in some embodiments described herein, amendments to the basket total are possible. References to payments below are intended to refer to payments using a user token and not to payments made using cash. It is noted, however, that some embodiments described in the present disclosure may be utilised alongside a cash payment.

Payments made using a user token are facilitated by a payment system. A user token is issued to each user by their payment account provider, or issuer, to allow the user to make a payment via a payment system. The user token is generally in the form of a payment card. The payment card links the user to their payment account and allows identification of that account when required at a plurality of different merchants. In this regard, the payment card may be considered as a general purpose payment card because it is standardised to enable use with many payment systems. The payment card is also provided with one or more security requirements to allow payments or transactions to be made only when each of the security requirements are fulfilled. These security requirements are usually in the form of local identification of the user, and may also incorporate further verification performed by the payment system.

Using a series of fixed authorisation steps, the payment is facilitated. The user is generally required to enter an authorisation code or personal identification number (PIN) during the authorisation process to allow the transaction to proceed. However, in some circumstances, a contactless payment or NFC payment may be permitted that does not require a PIN. Whether the user chooses to pay with their payment card using chip and pin, using a contactless payment protocol, or by an NFC payment using a digital wallet, the respective processes performed by the payment system are very similar, with minor variations between the two information flows, as is explained below.

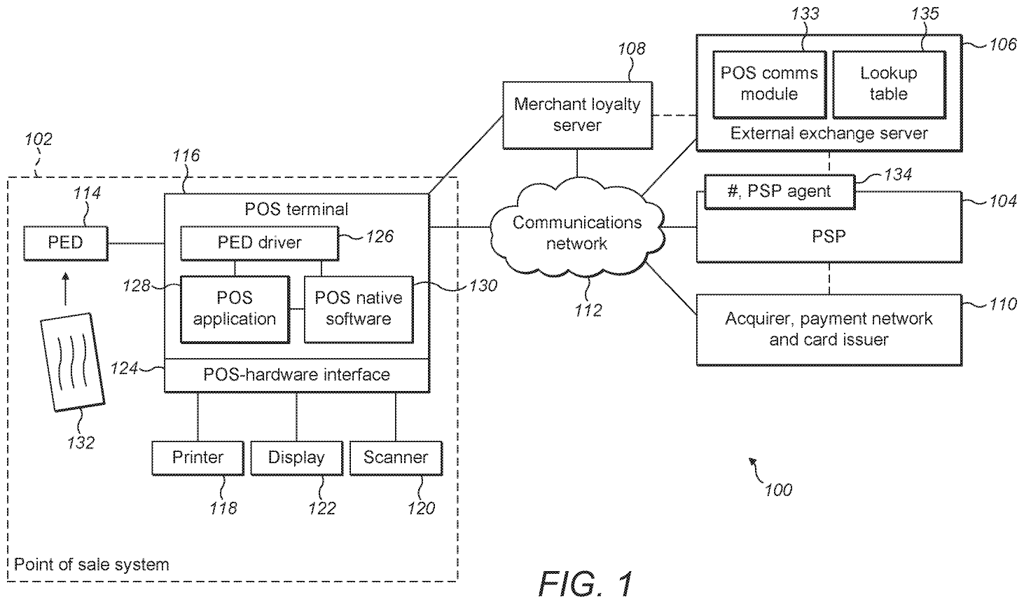

An example payment system 100 according to an embodiment of the invention is illustrated in FIG. 1 including the highlighted elements. The payment system 100 facilitates the payment cycle. Specifically, the payment system 100 facilitates the payment interaction between a user using a user token and a merchant from whom the user is purchasing goods or services with the user token. The payment system 100 acts as a third-party interface between the user and merchant to allow a transaction to be enacted between the respective payment service providers of the user and merchant.

The system 100 comprises a point-of-sale (POS) system 102, a payment services provider (PSP) 104, an external exchange server 106, a merchant loyalty server 108, and payment systems 110 comprising an acquirer, a payment network, and a card issuer. The components are configured to communicate directly with one another, or via a wide-area communications network 112.

The POS system 102 comprises a PIN entry device (PED) 114, a POS terminal 116, a printer 118, a scanner 120, and a display 122 which may incorporate mechanisms for user input such as a touch screen or physical buttons. The POS terminal 116 comprises a POS hardware interface 124 configured to interact with the printer 118, scanner 120, and display 122. The POS terminal 116 also runs software modules that facilitate transactions, comprising a PED driver 126, a POS application 128, and a POS native software 130. It will be appreciated that the POS system 102 may also comprise a number of displays, scanners, or other entry devices for use by an operator or by the user. For example, a typical self-service POS system may additionally comprise two barcode scanners, a display, coin and note slots/readers and/or a packing area.

The PED driver 126 is a software agent (program) that resides on the base Operating System (OS) of the POS terminal 116. The PED driver 126 can be considered to be an agent controlled by the PSP 104 and its responsibilities are to facilitate transactions between user and merchant devices such that it is not necessary for the software run at the POS terminal 116 to have requirements for the authorisation process laid out or to have industry standards built into them. The PED driver 126 comprises software that facilitates the implementation of standards required by the payment services industry. In particular, the PED driver's responsibilities are to facilitate EMV, which stands for Europay, MasterCard and Visa and is a global standard for cards equipped with computer chips and the technology used to authenticate chip-card transactions, for both chip & pin or contactless transactions and negates the requirements for the EMV standards to be built into the POS software directly.

The POS native software 130 is software run by the POS terminal 116 that is common to all POS terminals in the merchant, and permits ordinary transactions to be made. The POS native software may also facilitate loyalty operations.

The POS application 128 is a feature not found in conventional payment systems, and so will be described in more detail later.

The user is depicted by their user token 132, in this case a payment card being presented to the PED 114. In use as a conventional payment system, the user, having been provided with the calculation of the cost, presents their payment card 132 to the PED 114 as part of the payment cycle. When invited to do so, the user inserts, swipes, or, in the case of a contactless payment, taps their payment card 132 at the PED 114. The PED 114 communicates with the POS terminal 116 which performs various checks and implements requests using the PED 114 and the other systems. To authorise a transaction, the POS terminal 116 communicates with the PSP 104 via the communications network 112. The PSP 104 also communicates with the payment systems 110 (the acquirer, payment network, and card issuer, as well as any additional parties such as additional acquirers, payment networks, or issuers, aggregators, processors, further payment service providers, or any other additional party that may be incorporated into the payment process), to facilitate authorisation, as well as settlement.

Returning to consideration of the payment cycle, an additional, usually optional step, is often incorporated between the main steps of calculation of cost to user and payment. In this additional step, the user is asked to provide a loyalty token or identifier (ID) if they are a member of the scheme associated with the merchant. The request is made by the POS system 102 via the display 122 or an operator of the POS system (i.e. a cashier).

Conventionally, the loyalty token/ID is presented to the scanner 120 for communication to the POS terminal 116, in one of two ways. Either the token/ID is presented during and simultaneously with the calculation of the cost; or the token/ID is presented after the calculation of the cost to the user, but prior to the payment step.

Typically, the POS terminal 116 uses data gained from the loyalty token to communicate with the merchant loyalty server 108, which stores data relating to users and their loyalty tokens. The merchant loyalty server 108 confirms that the loyalty token is recognised as part of a loyalty scheme run by the merchant, and permits the POS terminal 114 to alter the cost to the user or offer rewards based on their membership of the merchant's scheme.

In both cases, conventional presentation of the token/ID occurs before payment has begun. While the system 100 of FIG. 1 does incorporate a scanner 120 for scanning conventional loyalty tokens, the system 100 is also capable of recognising a payment card 132 as a loyalty token by using the supplementary POS application 128 and the external exchange server 106 to provide a bridge between the PSP 104 and the merchant loyalty server 108. The PED driver 126 is also upgraded to operate in various new operational states, beyond those utilised by conventional PED drivers. A PSP agent 134 is also provided at the PSP 104, both for aiding with implementation of the new capabilities of the system 100. In incorporating the new PED driver states 126 and the external exchange server 106 and POS application 128, the system 100 joins the previously incompatible payment and loyalty systems to provide a seamless interaction between the user and the POS system 102, with minimal time wastage, and maximisation of insights into user habits for the merchant. As is explained throughout this description, the introduction of a POS application 128, its effects on the PED driver 126, and the operation of the external exchange server 106 facilitate an interruption of the payment cycle without breaking or halting the cycle entirely and without requiring a restarting of the entire cycle to complete the process. The interruption temporarily intercepts data used in the payment cycle for use in the loyalty processes, before permitting resumption of the payment cycle. The new process reduces the time required to perform a loyalty and payment operation together at a POS system and simultaneously reduces the input required from a user and/or cashier at the POS system.

The method of operation of the system 100 incorporating the POS application 128, PSP agent 134, and external exchange server 106 is discussed below, but the main functions of the POS application 128 and the external exchange server 106 will now be discussed.

The POS application 128 cooperates with the PED driver 126 during the newly introduced operational states of the PED driver 126 to enact a loyalty process during the payment cycle according to embodiments of the invention. The POS application 128 enables the POS terminal 116 to receive an injection of a membership ID for identifying the user as a member of the loyalty scheme. This is implemented using an input in the form of a POS bus injection. The membership ID is therefore input to a bus of a device connected to the POS, to give the appearance that the data was received from that device. For example, the system injects the membership into the POS terminal via a bus of the scanner 120. The POS application 128 also incorporates an open POS bus capture, which is capable of intercepting bus messages such as receipt data. The POS application 128 configures the POS terminal 116 for communication with the external exchange server 106 and is capable of communicating a status update to the external exchange server, as well as being capable of receiving and sending information relating to the user from and to the other components of the system. The POS application 128 also incorporates additional actions for operation by the cashier such as information screens or buttons.

The PSP agent 134 operates to decrypt sensitive data received from the POS system 102, create a non-sensitive version of the decrypted data suitable for sending to the external exchange server, send the new version of the data to the external exchange server 106, to receive, in response, an identity of the user found in the loyalty server 108, and to return the identity to the POS system 102. The non-sensitive version of the decrypted data is in the form of a hashed identifier, created using a hashing algorithm, and, optionally, a merchant identifier or system identifier. The hashing algorithm may also be applied to the merchant identifier. Alternatively, the decrypted data and the merchant identifier may be incorporated within a single hashed identifier. For example, the hashing algorithm may be merchant-specific so that the hashed identifier always identifies the merchant too. The term merchant identifier or merchant ID may be the MID of the merchant or a different identifier. Each of these steps is elaborated on in relation to the interaction diagrams described below.

The external exchange server 106 incorporates various APIs for receiving and communicating information to the other actors in the system 100. The external exchange server 106 as a membership lookup module, which is configured to receive at least a hash from the PSP 104, as well as a merchant ID if required. The external exchange server 106 is also configured to retrieve a membership ID of the user that corresponds to the hash from a merchant data store bin in the merchant loyalty server 108, and to send the retrieved membership ID (or exception if no ID found) to the PSP 104.

The external exchange server 106 also incorporates a module 132 configured for communication with the POS application 128. This module is capable of receiving a status from the POS application 128 and sending control signals to the POS application 128 indicating currently enabled modes of operation. A further feature of the external exchange server 106 is a user detail lookup module 134, which is configured to receive a membership ID from the POS application 128 and to send any loyalty user details corresponding to the membership ID to the POS application 128 in return.

As described above, a plurality of new states are used by the PED driver 126 during the loyalty process, and their purpose is described in more detail later. The new states utilisable at the PED driver are: Check Enablement; Request Lookup; ID Known; Notified; Tender Paused; Tender Complete; and Not Found.

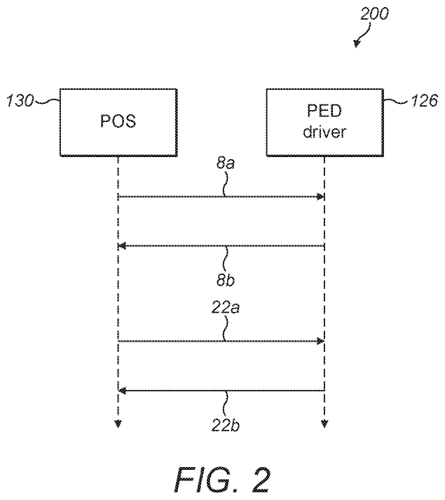

To provide context to embodiments of the invention as described in relation to FIG. 1 and later in relation to FIGS. 9 to 15, FIGS. 2 to 8 illustrate a typical prior art payment cycle, within which embodiments of the present invention may be incorporated and excluding any loyalty operations. Together, FIGS. 2 to 8 provide an overview of the interactions of a payment system such as the system 100 of FIG. 1 operating to facilitate transactions. The figures illustrate the processes of operation of the system, the interactions between the actors in the system, and any states in which particular actors operate, or the internal actions performed, in response to the interactions. FIGS. 2 to 6, 8 to 10, 14, and 15 are interaction diagrams demonstrating communications between actors, with time increasing vertically down each figure. These interaction diagrams are adapted to indicate operational states or modes or internal actions performed in response to an interaction where applicable. In each interaction diagram, states and internal actions are depicted as boxes adjacent the line corresponding to the relevant component.

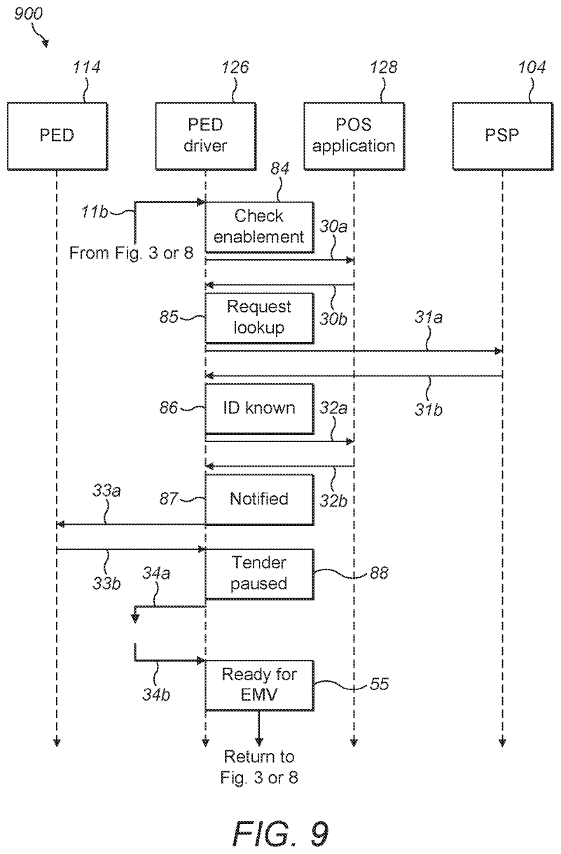

It is noted that conventional loyalty processes, namely those connecting to a second domain, are typically performed prior to the processes described in relation to FIGS. 2 to 8. The loyalty processes described according to the present embodiments are subsequently described in relation to FIGS. 9 to 15.

In the figures, requests communicated from one component to another are labelled with an identifying number followed by ‘a’. The response to each request from the other component back to the first component is labelled with the same identifying number followed by a ‘b’. For example, the first request (in FIG. 2) is a request for purchase labelled 8a. The response to that purchase request is labelled 8b (in FIG. 2) because it is a response to the request labelled 8a.

FIG. 2 illustrates an example payment interaction 200 in which the POS native software 130, here labelled simply ‘POS’ 130 communicates with the PED driver 126. In general, as shown in FIG. 2, the POS 130 communicates with the PED driver 126 in two request and response pairs.

The first request 8a made by the POS 130 to the PED driver 126 is a request for purchase, and is made after as it is indicated at the POS 130 that the final amount for the transaction has been calculated. The objective of this interaction is to achieve a request response 8b from the PED driver 126 that notifies the POS 130 that the payment was successfully authorised.

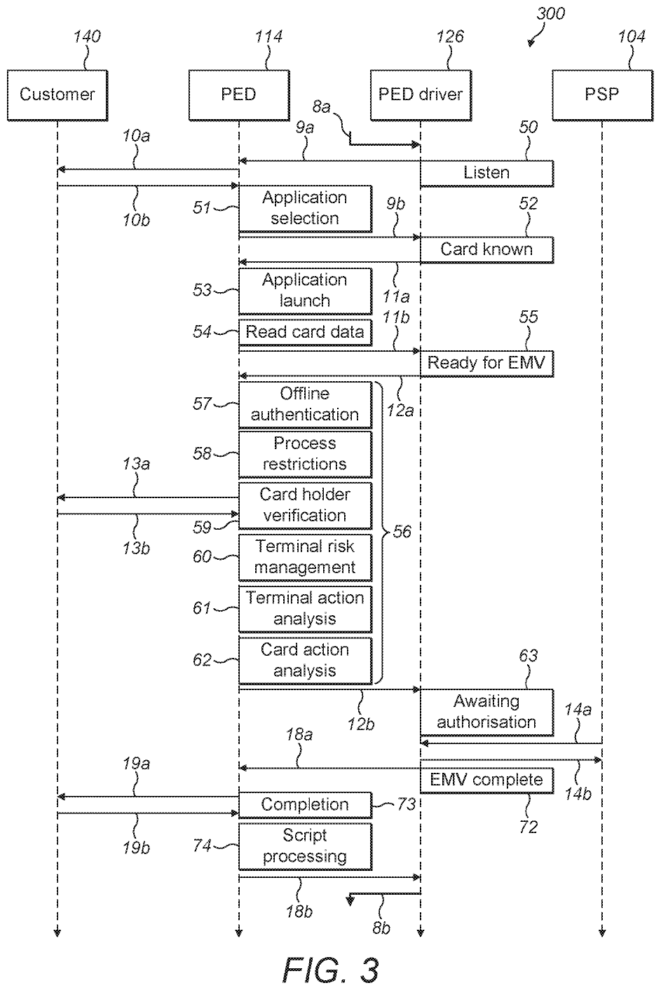

The request for purchase 8a from the POS 130 starts a purchase process interaction between the PED driver 126, the POS 130, the PED 114, and other actors in the payment system: a user 140 and the PSP 104. FIG. 3 shows an interaction diagram illustrating the purchase process 300.

Returning briefly to FIG. 2, the request for purchase 8a is responded to by the PED driver 126 following the process 300 of FIG. 3. The response 8b notifies the POS 130 that the payment was successfully authorised.

The second request 22a between the POS 130 and the PED driver 126 is a request for confirmation. The request for confirmation 22a occurs at the end of the transaction, after a receipt has been generated for the transaction. This request 22a ensures a transaction is logged against the account of the user. This request for confirmation 22a usually occurs automatically, however in much smaller deployments it can be a manually triggered task from a cashier/manager at the end of the day.

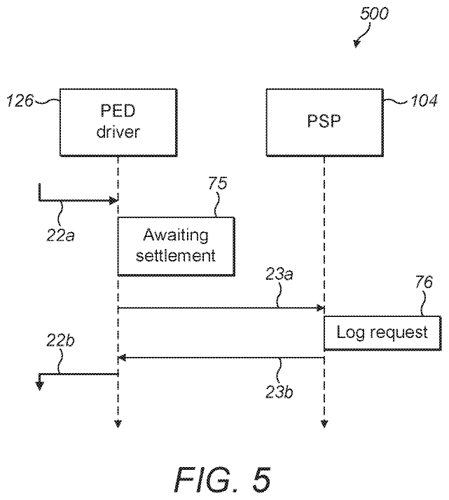

The request for confirmation 22a starts a confirmation process interaction between the PED driver 126 and the PSP 104, as will be described later with reference to the process 500 of FIG. 5.

Considering FIG. 3, the interaction for performing the purchase process 300 is executed between the PED driver 126, the PED 114, the PSP 104, and the user 140. The process 300 is considered to consist of seven stages. Five of the seven stages are delineated by the PED driver 126 entering a new state, and the other two stages are the initiation and completion of the process by the request and response for purchase 8a, 8b. The stages can be categorised as: (1) initiation of purchase process; (2) obtaining the identity of the user token; (3) obtaining sensitive data from the user token; (4) starting the EMV process; (5) obtaining authorisation for the transaction; (6) completing the EMV process; and (7) terminating the purchase process. Obtaining the identity of the user token is the determination that a user token has been presented and identifying the type of user token presented as this dictates how the token is read in the later steps.

In general terms, considering the payment system as a domain in which the user needs to be identified for an action, the purchase, to be performed, the seven stages described above can also be described as five general steps: (i) receive a request for identification of the user in the domain; (ii) obtain user identifier for use in domain; (iii) identify user in domain; (iv) authorise action based on identification; and (v) complete process, where step (i) corresponds generally to (1), (ii) to (2) and (3), (iii) to (4), (iv) to (5) and (6), and (v) to (7).

The first stage of the process 300, the request for purchase 8a, is followed by the second stage of the process 300; obtaining the identity of the user. The PED driver 126 enters a ‘listening’ state 50 in response to the request for purchase 8a, which, depending on configuration, could be for NFC and/or chip interactions, chip interactions being interactions using a payment card using a chip to allow chip-and-pin and contactless interactions. The PED driver 126 entering the listening state 50 indicates the start of the second stage. In the listening state 50, the PED driver 126 is effectively preparing for the insertion of the payment card and for receiving the identity of the payment card to initiate the next state.

Throughout the processes described herein, the PED driver 126 and PED 114 enter a number of states during the payment cycle and/or initiate internal actions. The states entered by the PED 114 and the PED driver 126 are default states that are standard processes that allow particular functions to be performed and information transfer to be effected between PED 114, PED driver 126, PSP 104 and any other connected element of the system 100. The PED driver states are dictated by a software program pushed to it from a payment service provider, and updates to the software program may introduce new states to allow the PED driver 126 to enter new states. As will be well understood by the skilled person, the PED states or internal actions are or are caused by scripts run by the PED 114 that trigger actions or communications to be performed with the payment card chip, that trigger a request to be displayed to the user, or that result in a response being generated to be communicated to the PED driver 126 to change the state of the PED driver 126 and progress the payment cycle to the next stage. In contrast to PED driver states, the PED 114 is configured to restrict the alteration or addition of states or scripts for security purposes. The PED 114 reads and uses sensitive information from the payment card, and so it is important that the operation of the PED 114 is not compromised.

When in the listening state 50, the PED driver 126 communicates a request 9a to the PED 114, indicating that the PED driver 126 is in the listening state 50, and that the user 140 should present a payment card 132 to progress the transaction. The PED 114, via a display screen 122 or other output means, communicates a request 10a to the user 140 to present a payment card 132 for progressing the purchase. In response, the user 140 presents 10b a payment card 132. In this case, the presentation 10b is a chip-and-pin interaction, meaning that the user 140 inserts the payment card 132 into a reader located in the PED 114.

Presentation 10b of the payment card 132 causes an application selection script 51 to run on the PED 114. The application selection script 51 runs to select an application based on the payment card 132 presented by the user 140. The script 51 communicates with the PED driver 126 by sending a response 9b to the request 9a for presentation of the payment card 132. The response 9b is sent in order to indicate that the card has been identified based on the script 51, and that a mutually agreeable EMV application within the PED 114 has been found for the card presented. In other words, the correct process for reading the card and achieving a smooth transaction is determined during this stage by identifying the standard the card uses. Having identified the card, the PED driver 126 enters the ‘card known’ state 52, indicating the transition from the second stage to the third stage of the process, in which sensitive data is obtained.

Once the identity of the card is known to the PED driver 126 and the PED driver 126 has entered the card known state 52, the PED driver 126 requests 11a the PED 114 to obtain sensitive cardholder data identifying the user/user account. The PED 114 launches the selected application 53 and a script 54 is run that reads the sensitive cardholder data from the payment card 132. This data received is encrypted, typically in a point-to-point encryption (P2Pe) environment, within the PED 114. The data is therefore rendered unreadable by the PED driver 126. This data is able to be decrypted within the PSP 104 later in the process. Ahead of the sensitive data being available, offline data authentication via SDA (Static Data Authentication), DDA (Dynamic Data Authentication), or CDA (Combined Data Authentication) may also be performed along with any card processing restrictions. These verify whether the card is allowed to conduct the transaction request.

The sensitive cardholder data obtained from the card is typically a payment account number (PAN), sometimes also called a payment card number or primary account number. The encrypted sensitive cardholder data, typically the encrypted PAN, is shared with the PED driver 126 as a response 11b to the request 11a for data. Receipt of the encrypted data causes the PED driver 126 to enter the ‘Ready for EMV’ state 55. The Ready for EMV state 55 indicates the beginning of the fourth stage of the purchase process 300, where the EMV process takes place.

Following the ‘Ready for EMV’ state 55, the PED driver 126 pushes 12a the transaction amount to the PED 114 and triggers a series of scripts 56 including an offline authentication script 57, a process restrictions script 58, a cardholder verification script 59, a terminal risk management (TRM) script 60, a terminal action analysis script (TAA) 61 and a card action analysis script (CAA) 62. The cardholder verification 59 verifies the identity of the user, i.e. the cardholder. Verification of cardholders for all online transactions within the UK is via a PIN (personal identification number). The PIN is known only to the holder and the issuing payment service provider. During the cardholder verification script 59, the PED 114 displays a request 13a to the user 140 for the PIN to be entered, and a response 13b is received in the form of the user 140 entering the PIN on an input device of the PED 114.

The TRM script 60 validates the need for an online authentication. A Terminal Action Analysis script 61 determines whether to decline offline or whether to go online. Finally, the card action analysis script 62 will either build an Application Request Cryptogram (ARQC) to go online, or an Application Authentication Cryptogram (AAC) to decline without requiring authorisation. Assuming the result is an ARQC, a response 12b is communicated to the PED driver 126 indicating that the EMV transaction scripts 56 have been successfully completed.

The ARQC is generated by enciphering card, terminal, and transaction data with the Master Key embedded within the chip (that was derived during personalisation from the Issuer's Master Key) or session key derived from the chip's Master Key. The resulting output is a 16 character HEX ARQC. In the case of the present application, it will be assumed that an ARQC is generated and that the card is not declined. If an AAC is generated, the PED 114 may communicate a request to the user to remove the card and reinsert, or may simply display a message declining the transaction, in which case the transaction may have to be restarted.

Carrying on with FIG. 3, in response to receiving the response 12b from the PED 114 that the EMV transaction was successful, the PED driver 126 enters an ‘awaiting authorisation’ state 63. The awaiting authorisation state 63 is the beginning of the fifth stage of the purchase process 300. In the awaiting authorisation state 63, the PED driver 126 sends the encrypted sensitive cardholder data, the ARQC, and the index of the Master key used to the PSP processing system 104 as a request for authorisation 14a and awaits a response.

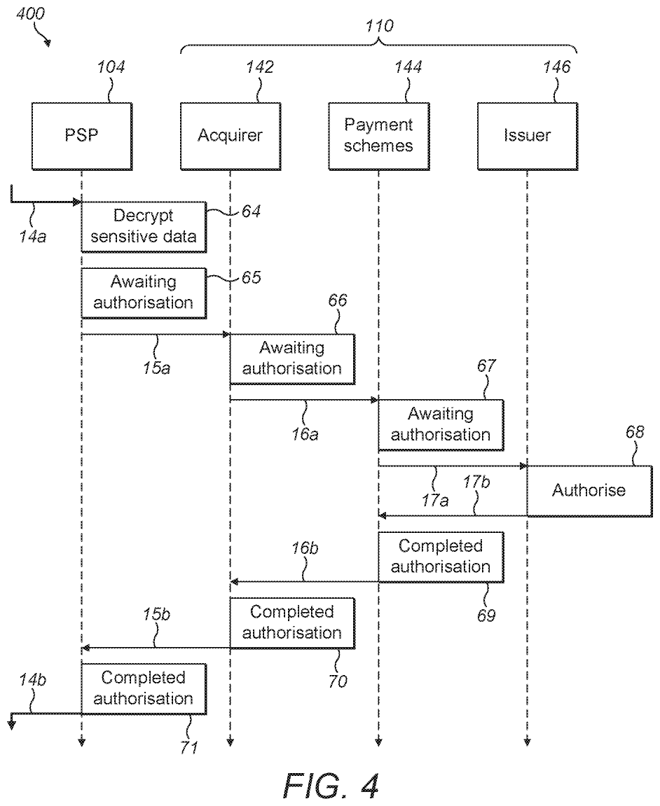

The PSP 104, upon receipt of the encrypted data, operates as illustrated in FIG. 4. FIG. 4 illustrates an authorisation process 400, and the relevant communications and states of the PSP 104, an acquirer 142, a payment scheme 144, and an issuer 146.

In the process 400 of FIG. 4, the PSP 104 receives the request 14a and decrypts 64 the encrypted sensitive cardholder data. A chain of authorisation requests 15a, 16a, 17a is communicated from the PSP 104 to the acquirer 142, from the acquirer 142 to the payment scheme 144 and from the payment scheme 144 to the issuer 146. Having communicated the authorisation request, each of the PSP 104, acquirer 142 and payment scheme 144 enter an ‘awaiting authorisation’ state 65, 66, 67 in the same way as the PED driver 126.

The issuer 146, which is the payment account provider that issued the payment card 132, verifies the ARQC by generating its own version and comparing, and also verifies that the necessary funds are present in the account of the user/cardholder to fulfil the transaction. If both these verifications are successful, the issuer authorises the transaction 68 and a chain of responses 17b, 16b, 15b is passed back to the PSP 104 and from there, a response 14b indicating the authorisation result is returned to the PED driver 126. Having communicated their respective response, each of the payment schemes 144, acquirer 142, and PSP 104 enter an ‘authorisation completed’ state 69, 70, 71.

The issuer 146 may pass back an optional ARPC which is a hash of the ARQC, plus some additional data such as the Authorisation Response Code or the Card Status Update. This is used by the chip when returned to validate that the authorisation was returned untampered from the issuer. If the issuer detects an inconsistency in the data received in its response, it can block the card or adjust the velocity limits to reflect the cardholder's offline purchasing power. EMV recommends that Authorisation requests are kept by Issuers.

Returning to FIG. 3, the PSP 104 provides the result of the authorisation as a response 14b to the PED driver 126. This response may include an ARPC and/or scripts to be executed on the chip of the payment card 132. The PED driver 126 enters an ‘EMV complete’ state 72 as a result, signifying the sixth stage of the process 300, and communicates a request 18a to the PED 114 indicating that the EMV is complete. The PED 114 completes the EMV process by executing any remaining scripts: ‘completion’ 73 and ‘script processing’ 74. The scripts 73, 74 can modify the chip data to present a different verification and/or risk management profile in its next use.

Following any modification of the chip, the user 140 is requested 19a by the PED 114 to remove the payment card 132. When the user removes 19b the card, the PED 114 notifies 18b the PED driver 126, which subsequently returns a response 8b to the POS 130 indicating that the purchase is complete, the final, seventh stage of the process 300. The response 8b includes information resulting from the purchase and non-sensitive data to enable the printing of the basket receipt and/or payment receipt.

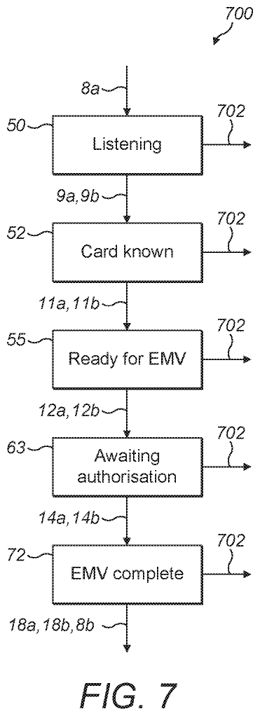

FIG. 7 illustrates a flow chart 700 showing the flow of operation of the PED driver 126 during the payment process 300. The operation begins with the receipt of the request for purchase 8a, and the PED driver 126 enters the listening state 50. The PED driver 126 sends a request 9a for presenting the card, and receives a response 9b which causes it to enter the card known state 52. The card known state 52 leads to another request 11a for sensitive data, and a subsequent response 11b causes the ready for EMV state 55. This leads to a request 12a for EMV transaction data, and a response 12b when the PIN of the user has been received. This causes the awaiting authorisation state 63, which leads to the authorisation requests and responses 14a, 14b, leading to the EMV complete state 72. Finally, the requests 18a and 18b are made, and the request for purchase is responded to in response 8b indicating that the purchase is complete.

At any point, if the PED driver 126 identifies a denial or an error, it communicates this as a request 702 to the PED 114 to display an error message to the user 140.

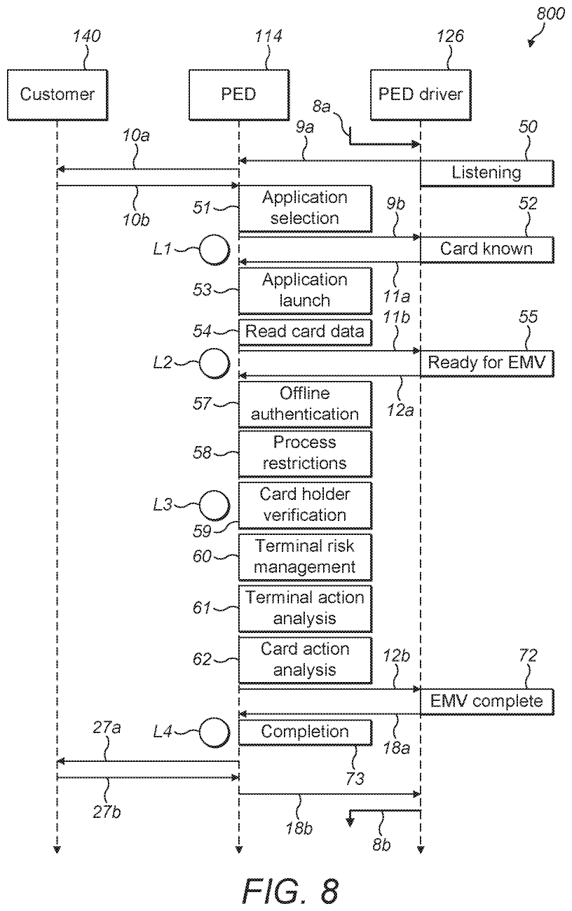

The process 800 performed to carry out a contactless payment, in which the user taps the payment card on the PED 114 rather than inserting it into a dedicated slot, is illustrated in FIG. 8.

The contactless process 800 is broadly similar to the contact process 300 discussed above. Instead of inserting their card 132, the user 140 hovers or taps their card 132 above or on the PED 114 and watches 4 buttons light up in sequence. As with the contact process 300, all conventional loyalty cards/vouchers/coupons must be entered before the cashier puts the POS software into tender mode (i.e. finalises the purchase and requests purchase so that the PED driver enters listening state).

Particularly, one light of the four light up after the following milestones: the card is identified (L1), when the EMV stage begins (L2), when the cardholder is locally verified (L3), and when the transaction is complete (L4).

It is of particular importance to note that the contactless process 800 lacks the input of a PIN into the PED 114 by the user 140 at the card holder verification stage 59, or an externally communicated authorisation step 14a, 14b. Instead, the next state of the PED driver 126 after the EMV response 12b is the EMV complete state 72 of the PED driver 126 and then the EMV complete request 18a. As contactless payments are carried out only for transaction amounts below a predetermined threshold value, these onerous cardholder verification steps are bypassed, and provided a local card holder verification and risk management are passed, then the transaction is permitted to proceed without the requirement for a PIN or authorisation from the PSP/issuer. The stages can still be considered to comprise the same seven stages, as authentication is carried out offline in the process of FIG. 8. However, the PED driver 126 does not enter an ‘awaiting authorisation’ state 63 to indicate the beginning of the authorisation stage, because the verification and authorisation of the user is carried out locally and offline at the PED.

A minor difference in the contactless payment card is the final request and response 27a, 27b to the user 140. Here, the PED 114 communicates to the user 140 an authorisation response, rather than requesting the user to remove their card. The effects of steps 27a and 19a, and 27b and 19b are the same.

It is noted that contactless transactions may, in some circumstances, be subject to a different kind of authorisation. As will be well understood by the skilled person, the awaiting authorisation state and other associated information flow from the contact process may be combined with the contactless process to produce a hybrid information flow, that may or may not require a PIN to be input. The embodiments of the invention described herein are compatible with many different payment cycles, regardless of where the authorisation is performed.

As described in relation to FIG. 2, following the purchase process, the request for confirmation 22a is communicated to the PED driver 126, and the confirmation process 500 of FIG. 5 is implemented. The confirmation process 500 is performed following a receipt being issued to the user 140.

In the confirmation process 500, the PED driver 126 enters an ‘awaiting settlement’ state 75 while it requests settlement from the PSP 104. The PED driver 126 sends a request for settlement 23a in the form of a transaction certification to the PSP 104. The PSP 104 logs 76 the settlement or transaction against the correct account. Having logged 76 the request 23a,the PSP 104 provides a response 23b the PED driver 126 that the request has been logged. A confirmation 22b can be provided by the PED driver 126 to the POS 130 in response to the initial request for confirmation, and consequently the transaction process 200 is complete.

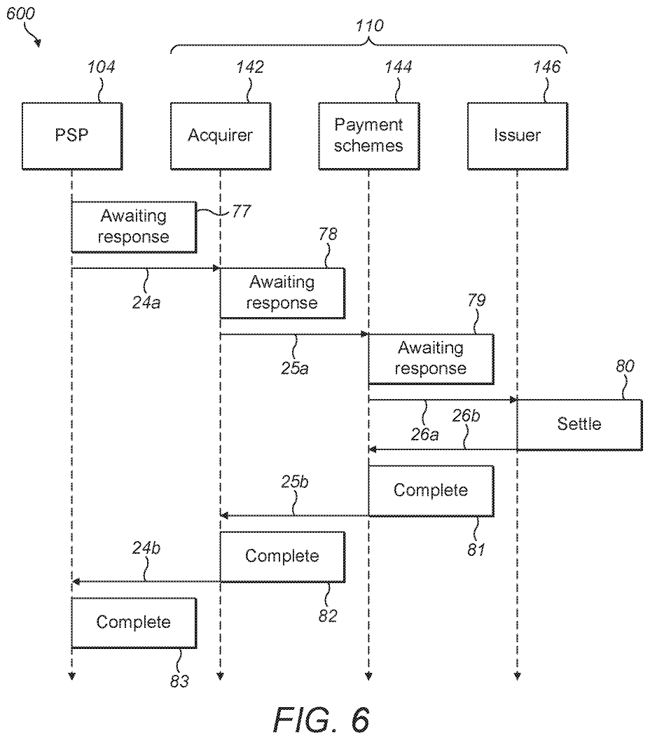

An example settlement process 600 is illustrated in FIG. 6. Settlement is generally performed after the user has paid for and departed with their goods and the transaction process 200 is complete. Settlement is processed as part of a batch, at a later time, according to a frequency and other requirements set by the payment network acting through the acquirer, or another actor. Settlement is the process by which the PSP 104 communicates with the issuer 146 of the user's payment card to settle the transaction, ultimately transferring the funds from the user's payment account to the merchant via the acquirer.

In the settlement process 600, a chain of requests for settlement 24a, 25a, 26a are passed from the PSP 104 to the acquirer 142 to the payment scheme 144 to the issuer 146, while each of the PSP 104, the acquirer 142, and the payment scheme 144 enter a state 77, 78, 79 of awaiting a response. The issuer 146 settles 80 the transaction and responds 26b, causing a return chain of responses 26b, 25b, 24b back to the PSP 104. After each response is received, the payment scheme 144, acquirer 142, and PSP 104 enter a ‘settlement complete’ state 81, 82, 83.

It will be understood by the skilled peson that settlement may be carried out in a number of ways other than that shown in FIG. 6, and the method shown in FIG. 6 is one method depicted for completeness. Settlement is not the subject of the present application, and so will not be discussed further.

To facilitate a seamless loyalty process that does not involve a user having to fiddle around with multiple loyalty tokens when purchasing their goods or services, the external exchange server 106 and POS application 128 can be incorporated into the payment system as described above in relation to FIG. 1, and new states can be programmed into the PED driver to create new interactions between the actors in the payment cycle. The processes and operation of the updated system 100 of FIG. 1 will now be described with reference to the new loyalty processes of FIGS. 9 to 13.

FIG. 9 is an interaction diagram according to an embodiment of the invention. The diagram in FIG. 9 illustrates a loyalty process 900 that may be incorporated into the payment process 300 as detailed in FIG. 3, making use of the POS application and the external server. The interaction diagram shown in FIG. 9 requires only a single identifying token, in this case a payment card, to allow identification of the user for two separate systems. This combined system reduces the time required for a purchase process to be carried out by facilitating both a payment cycle and a loyalty identification to be carried out via the PED and PED driver simultaneously. Importantly, the incorporation of the so-called secondary identification system, i.e. the loyalty system, does not hamper or disrupt the performance of the original payment process, but instead pauses and briefly interrupts the flow of the payment process.

While a single payment system and a single loyalty system are discussed in this application, it will be appreciated that the integration of multiple payment systems with multiple loyalty systems is possible, and that a single payment system may interact with multiple loyalty systems, or multiple payment systems may interact with a single loyalty system. Furthermore, a single identifying token may be utilised to identify a user in multiple payment systems and multiple secondary identification or loyalty systems. Similarly, a multiple identifying tokens may be ‘connected’ to a single user ID in one loyalty system.

To facilitate the combination of the payment and loyalty cycles, the process 900 of FIG. 9 is, in one embodiment, incorporated into the process 300 of FIG. 3 following the receipt 11b of encrypted data by the PED driver 126 and before the PED driver 126 enters the EMV ready state 55.

So, beginning from the start of the whole combined cycle, the first step in the payment cycle is performed and completed by the calculation of the cost to the user being totalled. The purchase process 300 is initiated and the request for purchase 8a is communicated to the PED driver 126 from the POS 130. The request for purchase 8a results in the conventional listening state 50, as discussed previously in relation to FIG. 3. The request indicating listening state 9a is communicated back to the PED 114 and requires the user to use their payment card to allow the transaction to be authorised 10a, 10b. The payment card data is identified by the PED 114 and the PED driver 126 enters its card known state 52, another previously known state as described above.

Sensitive data is requested 11 a by the PED driver 126 and returned 11 b by the PED 114 in the form of encrypted data. In the process 300 of FIG. 3, the PED driver 126 would ordinarily continue with the steps of entering the ‘ready for EMV’ state 55 and processing the transaction according to the protocols set down for it having received the encrypted data. However, according to this embodiment of the invention, the PED driver's operation differs from the process 300 in FIG. 3 at this point, and the receipt of encrypted data 116 results in the beginning of the process 900 shown in FIG. 9.

In the loyalty process 900 shown in FIG. 9, the PED driver 126 initially enters a new ‘check enablement’ state 84. It will be appreciated that while the PED driver 126 does not enter the ‘ready for EMV’ state 55 at this point, it does enter this state later on, once the purchase process 300 has been resumed. Therefore, it can be said that the PED driver 126 has not altered its work-flow, but simply postponed or paused the purchase process until a loyalty check has been performed. In this way, the purchase process and the fixed steps of that purchase process are not altered in any way, but the process is merely interrupted to allow the loyalty process to take place.

From the check enablement state 84, the PED driver communicates with the POS application 128 to confirm the available modes. A request 30a is sent from the PED driver 126 to the POS application 128 to confirm if the POS application 128 is configured to carry out the lookup. The lookup can be via an online process or may be performed during a payment cycle, as will be discussed below.

Once the POS application 128 has confirmed that the lookup is enabled by providing a response 30b to the PED driver 126; the ‘request lookup’ state 85 is entered by the PED driver 126. A lookup request 31a is sent to the PSP 104 by the PED driver 126. The lookup request 31a is enacted at the PSP 104, which decrypts the encrypted data received from the PED driver 126 and converts the PAN of the payment card to a hashed PAN using a predetermined algorithm via the PSP agent. Although not shown here, the hashed pan is then communicated, along with the merchant ID for identification of the correct loyalty programme, to the external exchange server 106, which compares the hashed PAN and merchant ID with pre-existing databases.

The lookup identifies an entry for the payment card hash/merchant ID in the databases and returns the loyalty member identification linked to that payment card to the PSP 104. The PSP 104 returns the identifier to the PED driver 126 as a response 31b to the request 31a. If no loyalty member identification can be found, a blank array is returned, the loyalty process stops and the payment cycle continues.

The PED driver 126 enters a new state ‘ID known’ 86, and subsequently communicates 32a the membership ID received from the PSP 104 to the POS application 128. In addition to the membership ID, the PED driver 126 may also communicate data regarding the user's transaction to the POS application 128. In this case, the POS application 128 is then able to assign the so-called ‘basket data’, i.e. information relating to the transaction, to the corresponding account. This assignment, although not shown in these figures, takes place by communication with the merchant loyalty server 108.

The POS application 128 responds to the PED driver 126 with a response 32b that indicates that the data has been received from the PED driver, as well as any account information that may be of use at the POS terminal. For example, the promotional information may comprise the user's points total if the rewards to the user are quantified using points. Similarly, potential offers may be communicated to the POS for display to the user. In some circumstances, the information may be then printed onto the receipt, or an e-receipt, for later consideration by the user.

In some situations, a ‘clip-to-card’ protocol is employed by which offers specifically chosen by the user prior to the transaction taking place are offered to the user via the POS. The clip-to-card protocol is a complimentary mobile application that provides users the ability to scan payment cards and link to loyalty scheme member information. The protocol allows coupons, vouchers, and other user offers to be electronically attached to payment cards so that use of the payment card at particular merchants results in application of the associated offers to the user's basket. Personalised offers are surfaced in the application and users select which are attached or ‘clipped’ to the selected payment card. In its response to the real-time lookup service, the exchange server returns not only the loyalty membership data but also the identifiers of the any clipped offers. Like the loyalty membership data, an offer ID can be injected into the POS system allowing any discounts or loyalty benefits to be applied during the transaction at the till.

The PED driver 126 enters a notified state 87 and communicates 33a the indication that the data has been received and any promotional information to the PED 126. At the PED 114, a notification is presented to the user that their payment card 132 and membership of the loyalty scheme has been identified and accepted, although this is not shown here. The PED 114 confirms 33b to the PED driver 126 that this notification has occurred, and the PED driver 126 enters a ‘tender paused’ state 88.

It is envisaged that the notification is a message displayed on a display of the PED 114, although in some situations this may be the illumination of a light, a small identifying icon or even a sound. In some situations, a display of the POS may display the notification rather than the PED.

When the PED driver 126 has entered the ‘tender paused’ state 88, the user has been identified in the loyalty domain.

Having entered the tender paused state 88, the PED driver 126 communicates 34a to the POS 130 a query, effectively pausing the purchase process by querying the POS 130 as to whether the purchase should be cancelled. This step is not a full cancellation of the process, but a chance for alterations to the transaction value to be implemented should the user wish to employ any benefits accrued through their membership of the loyalty scheme. Therefore, this step is effectively a confirmatory step, allowing the operator to present pertinent loyalty information to the user prior to the full transaction being made, and requires the operator (who in some cases might be the user) to confirm that they wish to proceed with the transaction in its original state, with the full purchase amount, or that they wish to alter the transaction, if the basket amount (total amount for items being purchased) needs to be re-calculated. For example, the user may have accrued a number of rewards that they wish to redeem against the current transaction, and by pausing the transaction, the PED driver allows this discount to be applied.

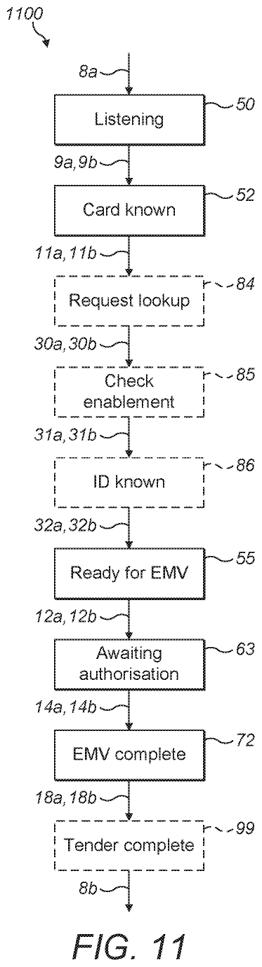

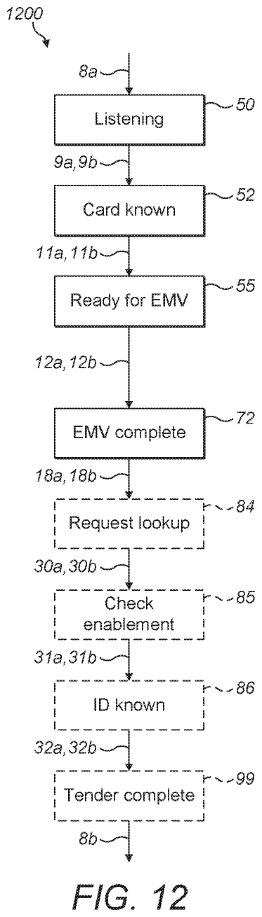

If the user wishes to continue with the original transaction, without applying any rewards or benefits, the operator of the POS 130 communicates 34b this to the PED driver 126, which recommences the payment process 300 from where it was effectively paused previously (after the card known state) by submitting the same request for purchase as submitted at the beginning of the flow of FIG. 3. From here, the EMV transaction is then begun, as the PED driver enters its ‘Ready for EMV’ state 55 and continues the purchase cycle with the PED 114 as would have happened in FIG. 3 had the interruption not occurred. At the end of the purchase process 300, the PED driver 114 enters a new ‘tender complete’ state 99 (see FIGS. 11, 12) to indicate that the purchase process 300 combined with the loyalty process 900 was completed successfully.

If the user requests that points or rewards are applied to their transaction, the POS 130 recalculates the value of the basket that is required to be paid by the user and makes a new request for purchase 34b to the PED driver 126, which again enters its ready for EMV state 55. At no point is the entire transaction restarted, and the user's payment card and information gathered from it is retained within the PED throughout. The PED driver therefore does not need to re-enter its listening state or card known state, because these two states have already been performed and the card has been received and identified. Instead, the process continues from where it was paused following communication by the PED of the encrypted data to the PED driver.

In some cases, the data returned to the PED driver 126 by the POS application 128 relating to promotional information may not contain any promotional gains for the user. In the embodiment shown, the PED driver 126 still requires a response 34b following the tender paused state 88 to enable to transaction to proceed.

So, once any necessary information has been presented to the user via an operator or POS terminal, and the user has chosen their preferred course of action, the process is continued by selecting an option at the POS, which results in a ‘request for purchase’ message 34b being communicated to the PED driver 126 once more.

As the PED driver has already received the encrypted card data from the PED, it can now enter the ‘Ready for EMV’ state 55. As described earlier, this continues the payment cycle protocol that was interrupted earlier in the process of FIG. 9 to allow the loyalty check to be performed. The PED driver received the encrypted data, and placed the payment cycle protocol on hold locally while the additional information was gathered during the process.

The payment cycle protocol subsequently continues as it ordinarily would, with the user being required to enter their PIN 13b to allow for authorisation 14b of the transaction to take place.

So, considering the five stages of purchase process as discussed above ((1) obtain card's identity, (2) obtain sensitive data, (3) start EMV process, (4) obtain authorisation, (5) complete EMV), the secondary process or check as outlined above is performed between steps (2) and (3). The sensitive data and card identity are both required to enable the secondary check to be performed.

In effect, a new stage is added, so that the stages are: (1) initiation of purchase process; (2) obtaining the identity of the user token; (3) obtaining sensitive data from the user token; (3A) loyalty process using sensitive data; (4) starting the EMV process; (5) obtaining authorisation for the transaction; (6) completing the EMV process; and (7) terminating the purchase process. Put this way, it can be seen that the purchase process is not affected by the insertion of the loyalty process and so security risks are minimised, and disruption to the user experience is also minimised.

In more generalised terms, where the payment system is a first domain and the loyalty system is a second domain, the updated steps of the process of the present embodiment can be considered to be (i) receive a request for identification of the user in at least the first domain; (ii) obtain user identifier for first domain; (iiA) identify user in second domain using user identifier for first domain; (iii) identify user in first domain using user identifier; (iv) authorise action based on identification in at least first domain; (v) complete process. Alternatively, rather than express this as an additional step (iiA), the interruptive loyalty process could be considered to be an extension of step (iii): identify user in both first and second domain using the user identifier. Again, this serves to demonstrate that the original process for purchase, which, prior to this disclosure, was seen as a process that had to be performed as a whole, is not altered or tampered with in any way. Instead, the inventors have identified that a temporary redirection of information used to identify the user in the first domain is an efficient mechanism by which to perform the identification in the second domain.

Additionally, the loyalty steps make use of sensitive data, the PAN, in a hashed, non-sensitive form. The PAN, which is utilised only by the PSP and payment systems in the conventional purchase process, is repurposed for use in the loyalty system. Repurposing the sensitive, identifying data to permit its use in a non-sensitive environment allows the incorporation of the loyalty process of FIG. 9 into the purchase process of FIG. 3. The identifying information exists in two forms, one form for identifying the user in each of the two domains. Again, this enables the efficient identification of the user in the second domain as the identification can be performed locally and quickly unlike conventional methods.

Existing solutions, as described above, adjust the authorisation process shown in FIG. 4 to patch a loyalty system into the issuing payment service provider. Entirely different components of the system are used for identifying the user in the loyalty system as are used for identifying the user in the payment system; the authorisation process, as expressed above in the generalised steps of the purchase process, is separate from the identification of the user.

It will be appreciated that the locality of the present process, where the loyalty step is performed almost entirely between the PED driver and the PSP, is in stark contrast to the adjustment of the authorisation process found in the prior art, and consequently leads to a low complexity system with low latency, high accuracy, and high security. The loyalty step, i.e. the identification of the user in the second domain, makes use of components of the existing system that are utilised in the identification of the user in the first domain. The external exchange server permits the repurposing of these components, by providing the bridge or catalyst between existing systems. So, identifying the user in the first and second domain makes use of the same identifying information, the same components, and neither identification is compromised by the other.

A further important distinguishing difference between the present embodiment and the known prior art is highlighted by the fact that the loyalty step of the present embodiment is wholly encapsulated within the original transaction. The purchase process contains the loyalty process, and no onerous cancellation and reinitiation of the entire transaction is required to implement the additional step. The flow from the request for purchase to the purchase complete response is maintained, and data gained during the transaction for use in the purchase process, i.e. the sensitive cardholder/user data, is not required to be resubmitted to permit each process or step to proceed. Again expressed in general terms, general steps (i) and (ii) are performed once, and the subsequent identifications are performed using the information gained from those steps. In some respects, the steps of identifying the user in each domain can be considered to be a split process, rather than a linear sequence of steps, as they do not depend on each other. The interruption makes use of natural windows and breaks that are found in the payment process and briefly pauses them to carry out the loyalty process in a non-disruptive manner.

A further point of note is that the system effectively simulates the presentation of a loyalty token to the scanner by using a bus injection scheme. While this is not the only way that this process can be performed, using a bus injection to simulate the receipt of a user identifier advantageously reduces the amount of modification required to permit the system to carry out the identification processes described herein.

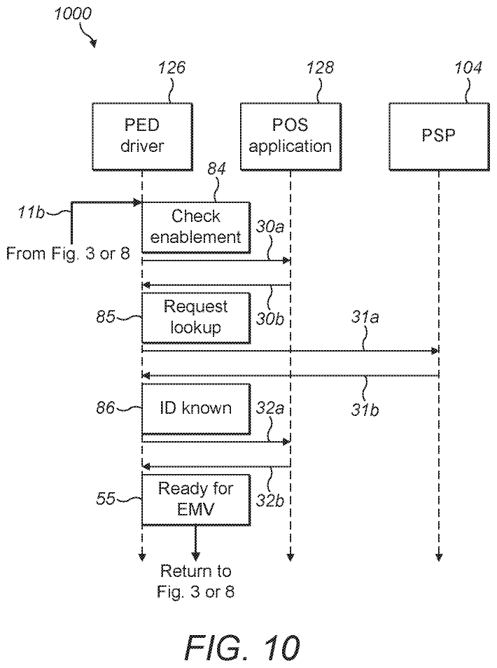

An alternative loyalty process 1000 is shown in FIG. 10. In this embodiment, the process 1000 is substantially similar to the process 900 of FIG. 9, and uses the same system 100. The processes of FIGS. 9 and 10 differ as there is no confirmatory step 34a, 34b to proceed with the payment or tender paused state 88. Instead, having determined the identifier associated with the payment card 132, the POS application 128 confirms to the PED driver that it has received the loyalty data and this confirmation permits the PED driver to continue to perform the authorisation process according to the conventional payment cycle protocol. The advantage of this is that the payment process protocol that is being carried out appears to the user to be the conventional payment cycle protocol, and so there is no confusion or delay at the POS terminal 102 despite rewards being accrued. In this embodiment, it may also be possible to display a message to the user via the PED or POS following completion of the transaction so that the user knows that they were successfully rewarded for their purchase. Furthermore, this process is therefore not delayed in any way.

While the process 1000 of FIG. 10 is presented above as being carried out prior to the EMV stages of FIG. 3, it is equally possible that the PED driver 126 may implement the process 1000 shown in FIG. 10 simultaneously with other stages of the process using parallel processing threads. As the process 1000 of FIG. 10 does not incorporate a confirmation, parallel stages or steps increase the speed of the purchase process further.

In fact, in general terms, step (iiA) could be performed at any point between steps (ii) and (v). An example of this is explained below with respect to the contactless process of FIG. 8.

FIG. 8, as already described, shows the conventional payment cycle protocol for use with a ‘contactless’ payment card. Advantageously, embodiments of the present invention are equally applicable to contactless payments, as they are not dependent on separate transactions or the presence of an authorisation. When used with contactless payments, the process of FIG. 9 or FIG. 10 is incorporated into the process of FIG. 8 immediately before the response from the PED driver to the POS indicating that the purchase is complete. That is, the 4th light L4 is lit, the authorisation response is communicated to the user and the card removed, the PED responds to the EMV complete request from the PED driver indicating that the process is completed at the PED and then the PED driver enters its check enablement state 84. Thus, the loyalty stage is enacted following completion of the first four stages of the contactless transaction, but without requiring the presentation of a separate token or the same token for a second time. In particular, it will be appreciated that the loyalty server 108 and external exchange server 106 again utilis the encrypted data received from the PED driver 126 to identify the user, and confirmation of the purchase is returned to the POS once the payment card has been identified and the rewards have been assigned.

When the process of FIG. 9 is incorporated into the process of FIG. 8, rewards and discounts can still be applied to the cost to the user, because the process is paused before the PED driver 126 communicates back to the POS that the process is complete. The verification steps of the process carried out offline by the PED are still valid because the reward or discount should not raise the cost to the user above the threshold value for which contactless payments are available.

It will be appreciated that it is possible to add several different functionalities into the process between the PED driver 126 receiving the encrypted data and entering the ‘Ready for EMV’ state 55, or in the case of contactless payment, between the ‘EMV complete’ state 72 and the ‘tender complete’ state 99. For example, if the user has not yet ‘linked’ their loyalty account to their payment card, a few additional steps may be inserted to allow the PSP to be sent a hashed PAN and merchant ID, and for the loyalty server to receive the necessary information required to allow it to assign the correct loyalty data. Alternatively, if the user has not yet joined the loyalty scheme, steps may be provided to allow the PED driver, PSP, POS application, loyalty server and external exchange server to interact to facilitate joining the scheme.

Speaking generally again, the new stage of identifying the user in the second domain is introduced following general step (iv) and before step (v) in the contactless process, or using the specific steps, following stage (6) but before stage (7). Once again, the embodiment makes use of a natural break to interrupt and co-opt the payment process for the loyalty purposes, without modifying or disrupting the already existing stages.

FIGS. 11 and 12 illustrates two process 1100, 1200 that present the operational states of and requests received by the PED driver 126 through the process 1000 of FIG. 10 when incorporated into the contact process 300 of FIG. 3 and the contactless process 800 of

FIG. 8 respectively. Original states of the PED driver 126 are illustrated with a solid line, while new states are illustrated using a dashed line. FIGS. 11 and 12 are an expanded version of FIG. 7.

It will be appreciated that the notified state 87 and the tender paused state 88 may also be incorporated following the ID known state 86, if the process requires pausing as in FIG. 9.

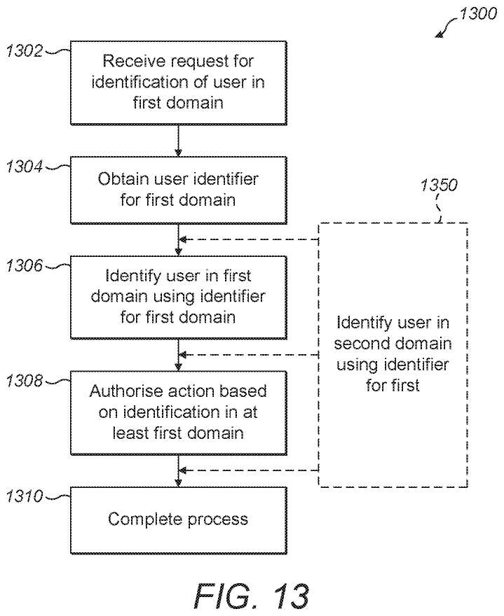

FIG. 13 illustrates the generalised steps of a process 1300 of identifying a user in two domains using a single identifier. As discussed above, there are five generalised stages to the process 1300: (i)) receive a request for identification of the user in the first domain 1302; (ii) obtain user identifier for use in the first domain 1304; (iii) identify user in the first domain 1306; (iv) authorise action based on the identification 1308; and (v) complete process 1310. As described above, once the user identifier for the first domain has been obtained 1304, the identification of the user in the second domain 1350 can be performed in between any of the stages before the completion 1310. It is important to remember that the identification of the user in the second domain 1350 is performed as a distinct step to the identification of the user in the first domain, and as a distinct step to the authorisation.

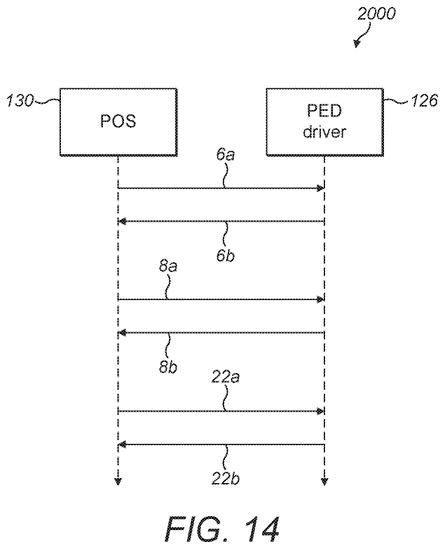

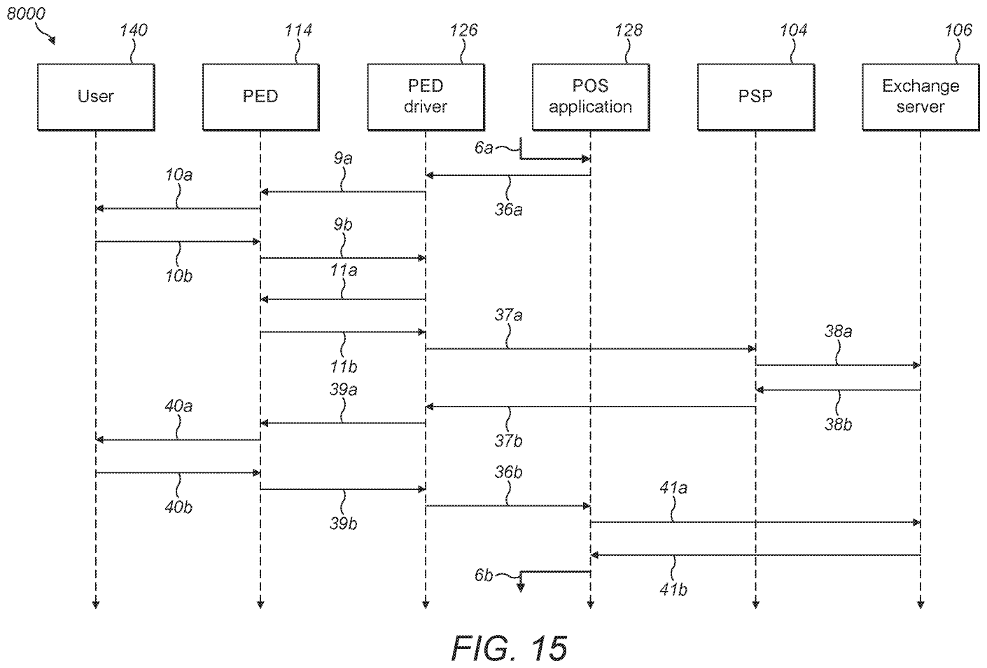

FIG. 14 illustrates an alternative embodiment of the payment process 2000 relating to a dual identification-authentication process, whereby the same identification token is used in two processes. FIG. 15 illustrates the first identification process 8000 relating to the identification of the user 140 in the loyalty domain using their payment card 132. The process following the new process 8000 in FIG. 15 is the purchase process 300 or 800 described earlier in relation to FIG. 3 or FIG. 8.

As shown in FIG. 14, which is an alternative payment cycle to the payment cycle of FIG. 2, three processes make up the payment cycle: loyalty process 6a, 6b; purchase process 8a, 8b; and confirmation process 22a, 22b. Each process comprises a request 6a, 8a, 22a from the POS 130 to the PED driver 126, and a response 6b, 8b, 22b from the PED driver 126 following completion of the request. FIG. 15 illustrates the loyalty process 8000, which is begun by the request 6a.

As can be seen from FIG. 15, once the transaction has begun, the POS application 128 sends a request for identification 36a of the user to the PED driver 126 as part of the loyalty identification process. The PED driver 126 sends a request 9a to the PED 114, which is then displayed 10a to the user. Effectively, these requests 9a, 10a mimic the initiation of the conventional purchase process 300, 800. Although states are not shown in FIG. 15, the PED driver state is the listening state 55 in response to the initial request from the POS application.

The user 140 presents 10b their card, either using the contactless or contact method at the PED 114, and the PED 114 and PED driver 126 operate to identify 9b the card in the same manner as the conventional purchase process 300, 800. The PED driver 126 here operates in the card known state. As in the purchase process, sensitive data is required 11a from the card, which is communicated 11b from the PED 114 to the PED driver 126 in an encrypted form.

Having received the encrypted information, the PED driver 126 enters the request lookup state 85 and communicates 37a the encrypted sensitive information to the PSP 104. Once the PSP 104 has received the encrypted data, it forms a hash of the PAN and communicates 38a this and a received merchant ID to the external exchange server 106, which responds 38b with a membership ID, having compared the hashed PAN and merchant ID with a database of hashed PANs. If the comparison returns no results, an empty array is returned to the PSP 104, and the loyalty process ends so that the payment process can begin.

Having identified the user in the external exchange server's 106 database, the ID of that member is returned 37b to the PED driver 126, which changes state to ID known 86. The PED driver 126 requests 39a the PED 114 to present a membership message and the user is notified 40a via the PED 114 that they have been identified using a ‘loyalty message’. This message notifies them that they can remove 40b their card from the PED 114. The PED 114 updates 39b the PED driver 126 to indicate the card has been removed. The PED driver 126 then communicates 36b with the POS application 128, which in turn cooperates 41a, 41b with the external exchange server to identify relevant information and promotions that may be pertinent to that user.

Following the identification of the user in the loyalty process, the ‘basket’, or transaction total, can be calculated to include all items that the user wishes to purchase and have any discounts applied. Once the loyalty process end response 6b is communicated, the purchase process 300, 800 begins.

The purchase process proceeds in the standard manner as shown in FIG. 3 or FIG. 8.

To consider the above another way, the same token is used in both processes to provide dual identification within a single system that is configured to operate for only one of those identification systems. The external exchange server acts as an intermediary to facilitate interaction between the identification-authorisation processes, despite the token being presented more than once.

It can be seen that the specific data from the token is still made use of, and several functions of the PED driver and PED are used to facilitate the look-up of the user in the loyalty scheme. This can be considered to be utilisation of data that is key to a first identification process, being used to facilitate a second identification in the same domain, where this would not have ordinarily been possible due to the incompatibility of these systems.

In some embodiments, the payment service provider and acquirer may be combined, and in other embodiments, the payment system may not include a payment service provider or acquirer. Instead, the payment flow may be redirected using a server or other module that acts in the same manner as a payment service provider. In other embodiments, the operations performed by the payment service provider may be performed locally at the POS terminal, or at the external exchange server, or distributed between the two.

It will be appreciated that any communications between components of the systems described herein are embodied in an appropriate control signal and/or message.

The contents of priority document GB1719666.8 are incorporated herein by reference.

1. A computer-implemented method for identifying a user in each of two separate domains using a single user identifier via a single identification system so as to permit authorisation of at least one action, the method comprising:
receiving a request to identify the user and authorise an action in a first domain;
performing a first identification process to identify the user in the first domain, the first identification process comprising:
receiving input data relating to the user at the identification system;
obtaining a first user identification key from the input data for identifying the user in the first domain and for authorising an action based upon the identification in the first domain;
identifying the user in the first domain by using the first identification key;
authorising the action based at least in part on the identifying step; and
terminating the first identification process; and
performing a second identification process to identify the user in a second domain after the first user identification key is obtained and before the termination of the first identification process, the second identification process being distinct from the steps of identifying the user in the first domain and authorising the action, and comprising:
obtaining a second user identification key based upon at least the first identification key and a system identifier; and
identifying the user in the second domain by using the second identification key.

2. The method of claim 1, wherein the first and second domains are independently controlled and configured for differing purposes.

3. The method of claim 1, wherein receiving input data relating to a user at an identification system comprises reading data from a user identifier in the form of a user token.

4. The method of claim 3, wherein the user token is a payment card, the identification system comprises a payment system, and the first user identification key comprises a payment account number.

5. The method of claim 1, wherein obtaining a second user identification key based upon at least the first identification key and a system identifier comprises comparing at least one of the first identification key and the system identifier with a database of first user identification keys, system identifiers and second user identification keys, and returning a corresponding second user identification key if a corresponding entry in the database exists.

6. The method of claim 5, wherein performing the second identification process comprises modifying the first user identification key and wherein comparing at least one of the first identification key and the system identifier with the database comprises comparing the modified first user identification key with the database.

7. The method of claim 6, wherein modifying the first user identification key comprises applying a hashing function to the key to obtain a hashed user identification key.

8. (canceled)

9. The method of claim 1, wherein the second user identification process is performed before the identification of the user in the first domain.

10. The method of claim 9, wherein performing the second identification process comprises modifying the action to be authorised based on the identity of the user in the second domain.

11. The method of claim 9, wherein performing the second identification process comprises temporarily redirecting the obtained first user identification key.

12. The method of claim 1, wherein the second user identification process is performed after authorising the action in the first domain.

13. The method of claim 12, wherein performing the second identification process comprises modifying the authorised action based on the identity of the user in the second domain.

14. (canceled)

15. A computer-implemented method for identifying a user in a second domain using a user identifier intended for identification of the user in a first domain within an identification system, the domains being separate, the method comprising:
commencing a first identification process to identify the user in the first domain by receiving, from the user identifier, input data relating to the user at the identification system, and obtaining a first user identification key from the input data for identifying the user in the first domain and for authorising an action based upon the identification in the first domain; and
having obtained the first user identification key, interrupting the first identification process and performing a second identification process to identify the user in a second domain, the second identification process comprising:
obtaining a second user identification key based on the first user identification key and a system identifier; and
identifying the user in the second domain by using the second identification key.

16. The method of claim 15, wherein obtaining a second user identification key based on the first user identification key and a system identifier comprises comparing at least one of the first identification key and the system identifier with a database of first user identification keys, system identifiers and second user identification keys, and returning a corresponding second user identification key if a corresponding entry in the database exists.

17. The method of claim 16, wherein performing the second identification process comprises modifying the first user identification key and wherein comparing at least one of the first identification key and the system identifier with the database comprises comparing the modified first user identification key with the database.

18. The method of claim 17, wherein modifying the first user identification key comprises applying a hashing function to the key to obtain a hashed user identification key.

19. (canceled)

20. The method of claim 15, wherein the first and second domains are independently controlled and configured for differing purposes.

21. The method of claim 15, wherein receiving input data relating to a user at an identification system comprises reading data from a user identifier in the form of a user token.

22. The method of claim 21, wherein the user token is a payment card, the identification system comprises a payment system, and the first user identification key comprises a payment account number.

23. (canceled)

24. A computer-implemented user identification system for identifying a user in each of two separate domains using a single user identifier via a single identification system so as to permit authorisation of at least one action, the system comprising:
a data input device for receiving input data relating to a user at an identification system;
a first domain ID key extractor for obtaining a first user identification key from the input data for identifying the user in a first domain and for authorising an action based upon the identification in the first domain;
a first domain server configured to identify the user in a first domain by using the first identification key in a first identification process;
an authorising server for authorising the action based at least in part on the identification of the user in the first domain;
an exchange server configured to obtain a second user identification key based upon at least the first identification key and the system identifier; and
a second domain server configured to identify the user in the second domain by using the second identification key in a second identification process, wherein:
the authorising server is functionally separate from the exchange server ID key and the second domain server.
